(19) United States
(12) Patent Application Publication
(10) Pub. No.: US 2005/0110357 A1
(43) Pub. Date: May 26, 2005

(54) Cable for winding coil and armature

(76) Inventors: Hiroshi Fukasaku, Aichi-ken (JP); Kiyoshi Uetsuji, Aichi-ken (JP); Ko Kajita, Gifu-ken (JP)

Correspondence Address: Morgan & Finnegan, L.L.P., 3 World Financial Center, New York, NY, 10281-2101, US

(21) Appl. No.: 10/968,634

(22) Filed: Oct. 19, 2004

(30) Foreign Application Priority Data
Oct. 20, 2003 (JP) 2003-359572

(51) Int. Cl. H02K 3/04; H02K 19/00; H02K 23/26

(52) U.S. Cl. 310/179; 310/203; 310/208

(57) ABSTRACT

A cable for winding coil, having been formed into a cable by bundling nine strings of conductor wires, forms a coil wound in a plurality of slots in a distributional manner by connecting each end of the nine conductor wires between different conductor wires thereof.

### BACKGROUND OF THE INVENTION

1. Field of the Invention

The present invention relates to a cable for winding a coil, and an armature, both of which form a coil wound in a plurality of slots in a distributional manner.

2. Description of the Related Art

There are, for instance, three examples of the conventional coil winding methods for generating a required magnetic field by winding a conductor wire in a prescribed slot of a stator or the like, as follows:

(1) A method in which, at first, winding a string of a conductor wire in a ring for several turns, followed by inserting the ring of the conductor wire into the prescribed slots in a stator by using an inserter, i.e., an apparatus for inserting a ring of conductor wire into the prescribed slots one by one in a manner pushing it upward from below, and thereby a predefined magnetic field is generated.

(2) Another method in which, if slots in a stator are of semi-closed slot, i.e., the circumferential width of the slot opening in parallel with the axial direction of the slot is narrower than the maximum circumferential width on the inside of the slot, winding a conductor wire directly around the prescribed slot by using a nozzle apparatus, i.e., an apparatus traveling in and around the slot while feeding out a conductor wire little by little from the nozzle thereon, and thereby a predefined magnetic field is generated.

(3) Yet another method in which, forming a flat conductor wire, whose cross section is rectangular, into a pine needle shape, or a V shape, inserting the pine needle shaped rectangular wire into the prescribed slot of a stator, followed by electrically connecting the flat conductor wire by welding edges of the flat conductor wires together, and thereby a predefined magnetic field is generated (refer to patent document 1 for instance).

[Patent document 1] Japanese patent laid-open application publication 63-274335 (FIGS. 1 through 13 on pages 2 through 4 therein).

However, the wire winding methods as described in (1) through (3) above have problems as follows.

The coil winding method as described in (1) above requires a large-scale coil winding apparatus such as an inserter, which costs a great deal for equipment as well as for the inserter itself. Also, the coil winding method as described in (1) above faces a difficulty in keeping a conductor wire, or a flat conductor wire, in line when winding it by the inserter.

And the coil winding method as described in (2) above requires winding a conductor wire in a slot turn by turn, and therefore the conductor wire in the slot becomes disorganized as a winding speed increases. As a result, the lamination (or density) factor of the conductor wires in a slot decreases, and hence a required magnetic field cannot be generated. Although it is possible to change the winding method in which winding the conductor wire closely in a lower speed, thereby improving the lamination (or density) factor of the conductor wires in a slot, a decreased production speed and therefore a decreased productivity will result, as much as winding the conductor wire closely. And the coil winding method as described in (2) above, if it is applied to a distributed winding, has a problem in keeping conductor wires in a slot parallel with the axial direction of the slot, making it difficult to align a plurality of the conductor wires with the contour of the slot.

Meanwhile, in the coil winding method as described in (3) above, as a flat conductor wire formed into a pine needle shape is inserted into a slot, enabling insertion of a plurality of conductor wires in the slot without creating unwanted space therein, it is beneficial in improving the lamination (or density) factor of the conductor wires in a slot. However, the coil winding method as described in (3) above has a problem of needing a number of sheets of insulation paper for insulating between the stator and each flat conductor wire since a stator has many slots, consuming as many man-hours, resulting in a reduction of productivity. Also, in the coil winding method as described in (3) above, there are a number of welding points between the pine needle-shaped flat conductor wires, consuming as many man-hours, resulting in a higher cost or a reduced productivity. Furthermore, the coil winding method as described in (3) above has a problem of being limited to the relatively low voltage applications, because the pine needle shaped flat conductor wires leave a narrow freedom in defining the number of turns, and the diameter of the stator increases with the number of turns, making altogether difficult to increase the number of turns.

### SUMMARY OF THE INVENTION

The purpose of the present invention is to provide a cable for winding coil, and an armature, both of which are applicable to a high voltage specification while improving the productivity, reducing the cost, being capable to align a plurality of conductor wires with the contour of a slot.

The present invention comprises the following aspects in order to solve the issues as described above.

Namely, the cable for winding coil according to the present invention, wherein a plurality of conductor wires are bundled so as to wind the plurality of conductor wires in a plurality of slots in an armature, and each end of the plurality of the conductor wires is connected between different wires thereof, thereby forming a coil wound in the plurality of slots in a distributional manner.

Alternatively, the cable for winding coil according to the present invention, wherein a plurality of conductor wires are bundled so as to wind the plurality of conductor wires in three or more slots in an armature, and each end of the plurality of the conductor wires is connected between different wires thereof, thereby forming a coil wound continuously in the three or more slots.

Alternatively, the cable for winding coil according to the present invention, wherein a plurality of conductor wires are bundled so as to wind the plurality of conductor wires in a plurality of slots in an armature, and each end of the plurality of the conductor wires is connected between different wires thereof, thereby forming a plurality of poles in the armature.

Alternatively, the cable for winding coil according to the present invention, wherein a first conductor wire and a second conductor wire are bundled together so as to wind the first conductor wire and the second conductor wire in a plurality of slots in an armature, and one end of the first conductor wire is connected with an end of the second conductor wire coming out of the same slot from which the other end of the first conductor wire comes out, thereby forming a coil consisting of the first and second conductor wires.

By the contrivance, it is possible to perform an installation process for winding one conductor wire in a plurality of slots in one assembly process, thereby increasing the productivity. And it does not require large-scale winding equipment such as an inserter, eliminating the use of the pine needle shaped flat conductor wire, thereby reducing the associated costs. It is also possible to wind a plurality of conductor wires while the plurality of the conductor wires are aligned well and therefore the wires are wound in a well aligned fashion. It is also possible to use conductor wires other than the flat conductor wire formed into a pine needle, thereby being applicable to high voltage specifications.

Alternatively, the above described cable for winding a coil, wherein the cable is bent at predefined intervals, thereby being in a wave form.

As such, the cable for winding a coil can easily be installed in a plurality of slots merely by inserting the cable for winding a coil into a plurality of slots as the cable is bent at predefined intervals, thereby being in a wave form. Alternatively, for instance, by bending a cable for winding a coil corresponding to the size of a stator, the coil end, i.e., a part of the cable for winding a coil crossing over a slot, becoming small, and thereby the whole armature size can be made compact. Alternatively yet, for instance, by bending a cable for winding a coil corresponding to the size of a stator, the required cable length becomes practically minimum.

Alternatively, the above described cable for winding coil, wherein the cable is covered with an insulation coating thereon.

By thus covering a cable for winding coil with an insulation coating thereon, there is no longer a need to install a sheet of insulation paper in each slot, eliminating an assembly process for installing a sheet of insulation paper in each slot, thereby improving the productivity as much.

Alternatively, the above described cable for winding coil, wherein the slot is featured in a stator of the armature.

Alternatively, the above described cable for winding coil, wherein the slot is a closed slot and the cable for winding coil is installed in the closed slot by thread winding.

Alternatively, the scope of the present invention is extended to an armature.

Alternatively, a winding tooling according to the present invention, wherein a tooling member is disposed for bundling a plurality of conductor wires while maintaining the alignment of the plurality of conductor wires, the tooling member is featured with a hole whose cross-section shape is the same as the cross-section shape of a slot in an armature and the alignment of the plurality of conductor wires is established by the hole.

By the contrivance, it is possible to wind a plurality of conductor wires in the slot while maintaining the whole cross-section shape of a plurality of conductor wires being approximately the same as the cross-section shape of the slot, thereby improving the lamination (or density) factor of the conductor wires in a slot.

Alternatively, the above described winding tooling, wherein each of the plurality of conductor wires can slide in the hole.

By the contrivance, it is possible to bend a plurality of conductor wires without difficulty.

Alternatively, a coil winding method according to the present invention, wherein a plurality of conductor wires are bundled whose whole cross-section shape is approximately the same as the cross-section shape of a slot of an armature, the bundled plurality of conductor wires are wound continuously in three or more slots, and each end of the bundled plurality of conductor wires is connected between different wires thereof, thereby forming a coil wound continuously in said three or more slots.

By the contrivance, it is possible to wind a plurality of conductor wires in the slot while maintaining the whole cross-section shape of a plurality of conductor wires being approximately the same as the cross-section shape of the slot, thereby improving the lamination (or density) factor of the conductor wires in a slot.

Alternatively, the above described conductor wire is a flat conductor wire.

By this, the lamination (or density) factor of the conductor wires in a slot can be improved as compared to a configuration using a round wire for the conductor wire.

The present invention makes it possible to perform an installation process for winding one conductor wire in a plurality of slots in one assembly process, thereby increasing the productivity, by such contrivance a plurality of conductor wires are bundled so as to wind said plurality of conductor wires in a plurality of slots in an armature, each end of said plurality of conductor wires is connected between different wires thereof and thereby forming a coil wound in said plurality of slots in a distributional way.

Also, it does not require large-scale winding equipment such as an inserter, eliminating the use of the pine needle shaped flat conductor wire, thereby reducing the associated costs.

It is also possible to wind a plurality of conductor wires while the plurality of the conductor wires are aligned well and therefore the wires are wound in a well aligned fashion.

It is also possible to use conductor wires other than a flat conductor wire formed into a pine needle, thereby being applicable to high-voltage specifications. It is also possible to wind conductor wires for a motor with a long axial size in which winding the conductor wires in the slot by using an inserter is difficult.

### BRIEF DESCRIPTION OF THE DRAWINGS

FIGS. 1A, 1B and 1C illustrate a cable for winding coil according to a preferred embodiment of the present invention;

FIGS. 2A, 2B, 2C, 2D, 2E and 2F illustrate winding tooling;

FIG. 3 illustrates a condition of a stator being wound by a cable for winding coil in a plurality of the slots thereof according to a preferred embodiment of the present invention;

FIGS. 4A and 4B illustrate another stator suitable for inserting a cable for winding coil according to a preferred embodiment of the present invention; and

FIGS. 5A and 5B illustrate another stator suitable for inserting a cable for winding coil according to a preferred embodiment of the present invention.

### DESCRIPTION OF THE PREFERRED EMBODIMENTS

Referring to the appropriate drawings, preferred embodiments according to the present invention are described as follows.

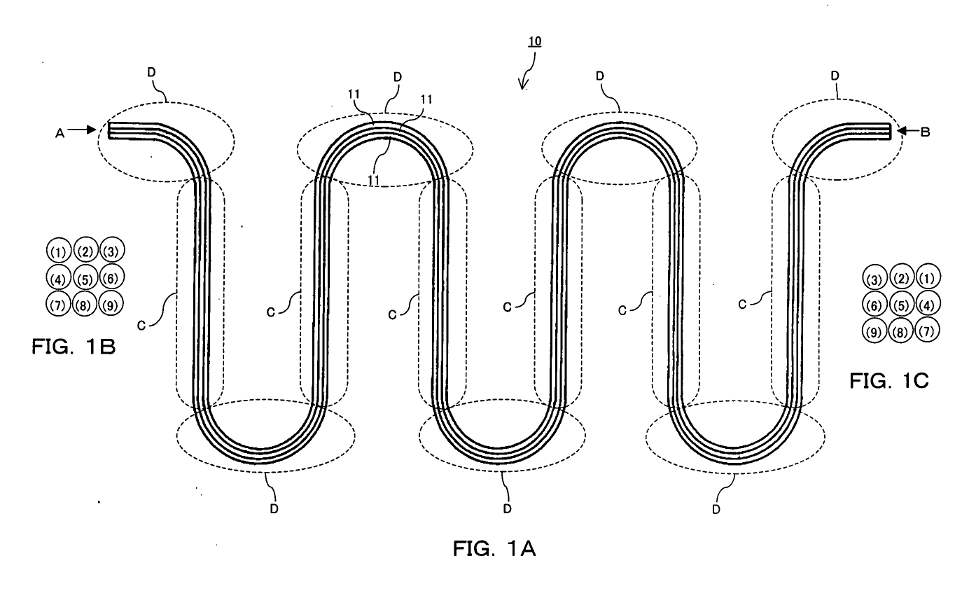

FIG. 1A illustrates a cable for winding coil according to a preferred embodiment of the present invention; FIG. 1B shows a view A of the cable for winding coil illustrated in FIG. 1A; and FIG. 1C shows a view B of the cable for winding coil illustrated in FIG. 1A.

A cable for winding coil (hereinafter called “cable”) 10 according to the present embodiment, as shown in FIGS. 1A through 1C, is formed into a cable by bundling nine strings conductor wires 11 (coated copper wires for instance) together. Note that each of the nine conductor wires 11 shown in FIGS. 1A through 1C is numbered (1) through (9). Also note that the number of the conductor wires 11 constituting the cable 10 is not limited to nine. Specifically for instance, bundling nine strings of the conductor wires 11 together and holding them by tape or the like in certain places can make a cable. Also, for instance, bundling nine strings of the conductor wires 11 and covering them with a plastic insulation film can make a cable. In the case of thus covering with a plastic insulation film, installing an insulation paper piece in each slot of a stator is no longer required, eliminating a process for inserting an insulation paper piece in each slot, thereby increasing the productivity as much.

The cable 10 according to the present embodiment, as illustrated in FIG. 1A, can also be pre-formed into a wave form by bending it at predefined intervals before installing it into a plurality of slots in a stator. By thus pre-forming the cable 10 into a wave form by bending it at a predefined interval, installing the cable 10 into a plurality of slots in a stator becomes easy.

Further, for instance, the cable 10 can be bent corresponding to each length of a part thereof, i.e., the part to be inserted to the slot (as shown by the dotted area C in FIG. 1A) and either end of the coil (as shown by the dotted area D in FIG. 1A). By thus bending the cable 10 corresponding to the size of a stator (the longitudinal length of the slot, and the length between the adjacent slots) beforehand, the coil end parts thereof can become small. This will make compact armatures, such as a motor, a generator and a linear coil. Also, by bending the cable 10 corresponding to the size of a stator the cable 10 can be used in practically minimum length.

Furthermore, the cable 10, after being inserted into a plurality of slots of a stator, each end of a plurality of conductor wires 11 in the cable 10 is electrically connected by soldering, or the like, between the different wires 11 thereof at one coil end between two certain continuous slots, thereby forming a single coil consisting of a single conductor wire which is wound in a plurality of slots in a distributional manner.

For instance, a method for configuring a single coil consisting of a single conductor wire by using the nine conductor wires 11, whose components (1) through (9) are shown in FIG. 1A, is described as follows.

First, the bundled nine strings of conductor wires 11, whose components (1) through (9), are inserted into the preconfigured six slots of the stator.

Next, the right end (component (1) in FIG. 1C) of the numerical (1) of the conductor wire 11 is connected with the left end (component (2) in FIG. 1B) of the component (2) of the conductor wire 11.

Then, the right end (component (2) in FIG. 1C) of the component (2) of the conductor wire 11 is connected with the left end (component (3) in FIG. 1B) of the component (3) of the conductor wire 11.

Then, the right end (component (3) in FIG. 1C) of the component (3) of the conductor wire 11 is connected with the left end (component (4) in FIG. 1B) of the component (4) of the conductor wire 11.

Likewise, after connecting each of the components (4) through (8) of the conductor wire 11 in turn, the right end (component (8) in FIG. 1C) of the component (8) of the conductor wire 11 is connected with the left end (component (9) in FIG. 1B) of the component (9) of the conductor wire 11.

As such, installing the components (1) through (9) of the conductor wires 11 into the six slots, and connecting between the ends of different wires in the conductor wires 11 so as not to end up with forming a closed loop, thereby configuring a single coil consisting of a single conductor wire by using the components (1) through (9) of the conductor wires 11.

Note that the number of coils consisting of a single cable 10 is not limited to one. For example, a first coil can be configured by connecting four of the nine conductor wires 11, and a second coil can be configured by using the remaining five of the conductor wires 11. By such a configuration, for instance, controlling the first, second or either one of all coils in use will configure a variable speed rotating electrical unit, such as a motor or a generator.

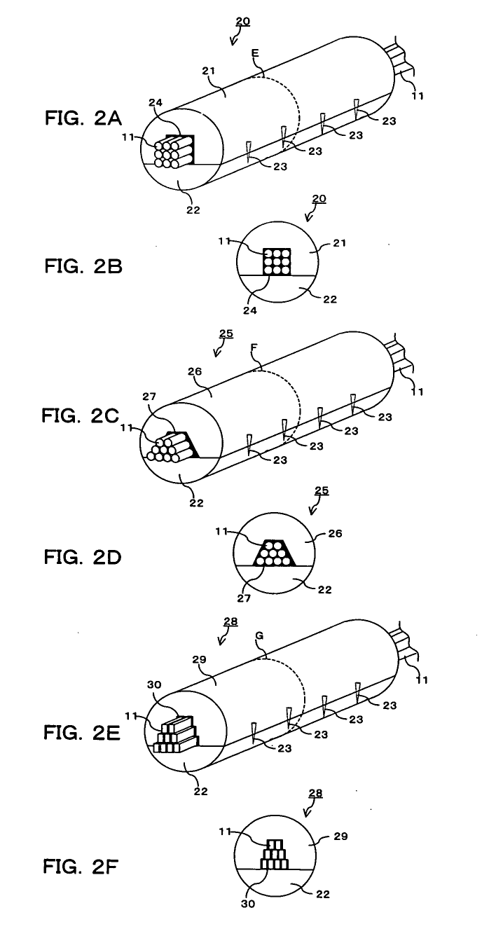

Next, a winding method of winding a plurality of conductor wires 11 in a slot is described as follows. FIG. 2A illustrates an example of winding tooling for winding a plurality of conductor wires in a slot.

FIG. 2A illustrates winding tooling 20 consisting of a tooling component 21 and a tooling component 22, both of which are aligned together so as to clamp a plurality of conductor wires in a predefined place, and fixed by screws 23. And the flat part of the tooling component 21 is featured with a groove from one end of the longitudinal direction thereof to the other end so as to form a hole 24 when the flat part of the tooling component 21 and the flat part of the tooling component 22 come into contact with each other.

FIG. 2B shows a cross sectional view, E, of the winding tooling 20 as delineated by FIG. 2A. As shown in FIG. 2B, the winding tooling 20 is featured with a hole 24 whose cross-section shape is a square. Note that the cross-section shape of the hole 24 can be configured so as to match approximately with the whole cross-section shape of a plurality of the bunched conductor wires 11.

Therefore, when the winding tooling 20 bundles a plurality of the conductor wires 11, the whole cross-section shape thereof becomes an approximate square. That is, for instance, when nine conductor wires 11 are bundled together by using the winding tooling 20, the nine conductor wires 11 are held aligned in three columns and three rows. And the nine conductor wires 11 can be wound in a slot with the cross-section shape being an approximate square while the nine conductor wires 11 aligning themselves in three columns and three rows.

As such, since a plurality of conductor wires 11, while maintaining the cross-section shape when the plurality of conductor wires 11 are bundled together being approximately the same as the cross-section shape of a slot, can be wound in the slot, the lamination (or density) factor of the cable 10 in each slot can be increased.

In the meantime, FIG. 2C shows another example of a winding tooling used for winding a plurality of conductor wires 11 in a slot. Note that the same numbers are assigned for the same features as shown in FIG. 2A.

As shown in FIG. 2C, a winding tooling 25 consists of a tooling component 26 and a tooling component 22, both of which together holding a plurality of the conductor wires 11 in certain places when coming together, in the same manner as shown in FIG. 2A. The flat part of the tooling component 26 is featured with a groove so as to form a hole 27 when the tooling component 26 comes to contact with the tooling component 22.

FIG. 2D shows a cross-sectional view, F, of the winding tooling 25 as delineated by FIG. 2C. As shown in FIG. 2D, the winding tooling 25 is featured with a hole 27 whose cross-section shape being a trapezoid. Note that the cross-section shape of the hole 27 can be featured to match approximately with the whole cross-section shape of a plurality of the conductor wires 11 bundled together.

And bundling a plurality of the conductor wires 11 together by using the winding tooling 25 forms the whole cross-section shape thereof into an approximate trapezoid. That is, for instance, bundling nine strings of the conductor wires 11 by using the winding tooling 25 holds the nine strings of conductor wires 11 in such away that four columns in the first row, i.e., the lowest row in the three rows of the nine strings of the conductor wire 11 stacked together as shown in FIG. 2D, three columns in the second row and two columns in the third row, as if straw bags or bricks are stacked together, in which configuration the nine strings of conductor wires 11 are maintained while being wound in a slot whose cross-section shape being approximately trapezoidal.

The winding tooling 25 too increases the lamination (or density) factor of the conductor wires in a slot, the same as the winding tooling 20 shown in FIG. 2A.

Note that in the cable 10 shown in FIG. 1 and FIGS. 2A through 2D, while the conductor wires 11 use a round wire whose cross-section shape being a circle, the conductor wires 11 for the cable 10 can use a flat conductor wire whose cross-section shape being a rectangle, or a conductor wire whose cross-section shape being an oval or a polygon.

FIG. 2E shows, in the case of using a flat conductor wire for the conductor wires 11 for the cable 10, an example of a winding tooling used for winding a plurality of the conductor wires 11 in a slot. Note that the same numbers are assigned for the same features as shown in FIG. 2A.

As shown in FIG. 2E, a winding tooling 28 consists of a tooling component 29 and a tooling component 22 together of which hold a plurality of the conductor wires 11 in certain places when coming together, in the same manner as shown in FIG. 2A. The flat part of the tooling component 29 is featured with a groove so as to form a hole 30 when the tooling component 29 comes to contact with the tooling component 22.

FIG. 2F shows a cross-sectional view, G, of the winding tooling 28 delineated by FIG. 2E. As shown in FIG. 2F, the winding tooling 28 is featured with a hole 30 whose cross-section shape being an approximate trapezoid. Note that the cross-section shape of the hole 30 can be featured to match approximately with the whole cross-section shape of a plurality of the conductor wires 11 bundled together.

And bundling a plurality of the conductor wires 11 together by using the winding tooling 28 forms the whole cross-section shape of thereof into an approximate trapezoid. That is, for instance, bundling nine strings of the conductor wires 11 by using the winding tooling 28 holds the nine strings of conductor wires 11 in such away that four columns in the first row, i.e., the lowest row in the three rows of the nine strings of the conductor wire 11 stacked together as shown in FIG. 2F, three columns in the second row and two columns in the third row, as if straw bags or bricks are stacked together, in which configuration the nine strings of conductor wires 11 are maintained while being wound in a slot whose cross-section shape being approximately trapezoidal.

The winding tooling 28 also increases the lamination (or density) factor of the conductor wires 11 in a slot, the same as the winding tooling 20 shown in FIG. 2A.

Meanwhile, by contriving such that each conductor wire in the plurality of the conductor wires 11 can slide in the hole 30 of the winding tooling 28, the cable 10 can easily be bent. In addition, by using a flat conductor wire for the conductor wire 11 instead of a round wire, the lamination (or density) factor of the conductor wires 11 in a slot is higher than the case of using a round wire for the conductor wires 11.

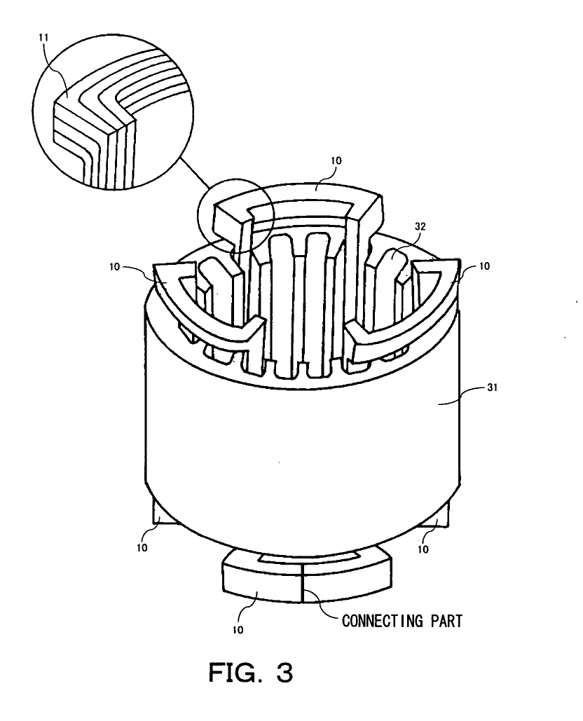

FIG. 3 illustrates a condition of a stator being wound in a plurality of the slots thereof by a cable 10 according to a preferred embodiment of the present invention.

As shown in FIG. 3, the cable 10, featuring the phase U of a three-phase motor (phases U, V and W), is inserted into six (6) slots 32, i.e., slots disposed for inserting in the inner circumference, of eighteen (18) slots 32 in a stator 31 at every third slot thereof. And, as shown in FIG. 3, connecting parts are formed by connecting, with solder or the like, respective conductor wires 11 in the cable 10 at an end of a coil between some two continuous slots.

Meanwhile, in one slot 32 of the two slots 32 where a cable 10 is not yet inserted, the cable 10 for the phase V will be inserted, while the cable 10 for the phase W will be inserted in the other slot 32. As such, three of the cable 10 will be inserted in the respective slots corresponding to the phases U, V and W, thereby generating the magnetic fields as required.

Note that, in the example shown in FIG. 3, the configuration is such that the cable 10 is inserted in six slots for forming six poles per phase, an alternative configuration can be such that the cable 10 is inserted into four slots for generating four poles per phase, or the cable 10 is inserted into eight slots for generating eight poles per phase.

As described above the characteristics of the cable 10 according to the present embodiment is bundling together a plurality of the conductor wires 11 for featuring the cable 10, inserting the cable 10 in a plurality of slots 32 of a stator 31 as a coil component, and connecting each end of the conductor wires 11 between different conductor wires 11 in the cable 10.

Meanwhile, in the case of the slot 32 being an open slot, i.e., the circumferential width of the slot opening in parallel with the axial direction of the slot is the same as the maximum circumferential width on the inside of the slot as shown in FIG. 3, inserting a cable 10 into a plurality of the slots 32 is easy when installing the cable 10 in the plurality of the slots 32. In the case of the slot 32 being an open slot, the cable 10 can be inserted therein without damaging a coating on the conductor wires 11.

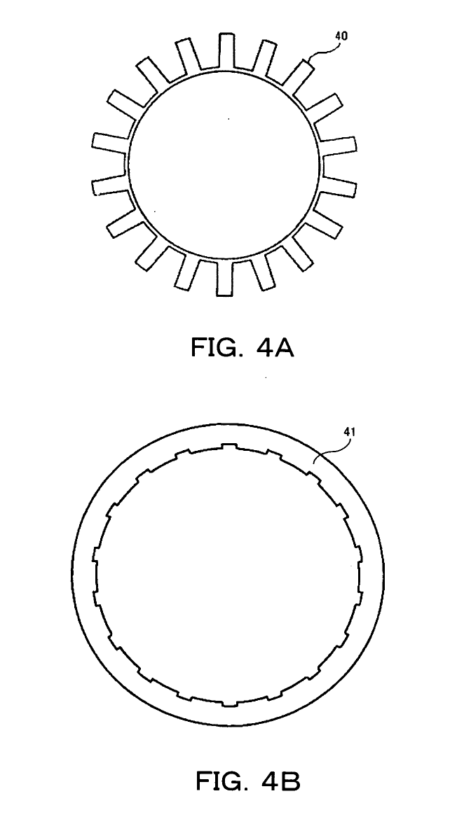

FIG. 4 illustrates another stator suitable for inserting a cable 10 according to a preferred embodiment of the present invention; FIG. 4A illustrates an inner ring 40 of the stator; and FIG. 4B illustrates an outer ring 41 of the stator.

The stator shown in FIG. 4 is a split stator consisting of the inner ring 40 and the outer ring 41, in an example of which eighteen (18) slots, i.e., slots disposed for inserting in the outer circumference, featured in the outer circumference of the inner ring 40 are disposed for inserting three cables 10 constituting the phases U, V and W in a respectively distributional manner. Then, after electrically connecting the respective conductor wires 11 in the three cables 10, the inner ring 40 and the outer ring 41 are fitted together.

Note that the respective conductor wires 11 in the cable 10 can be connected by soldering and the like at an end of a coil wound in any two continuous slots as shown in FIG. 3 for instance.

The cable 10 can be inserted into a slot whose opening is at least wider than the circumferential width thereof without damaging a coating of on conductor wires 11, as shown in FIG. 4.

Note that the electrical connection between the respective conductor wires 11 in three of the cables 10 can be done after fitting the inner ring 40 with the outer ring 41.

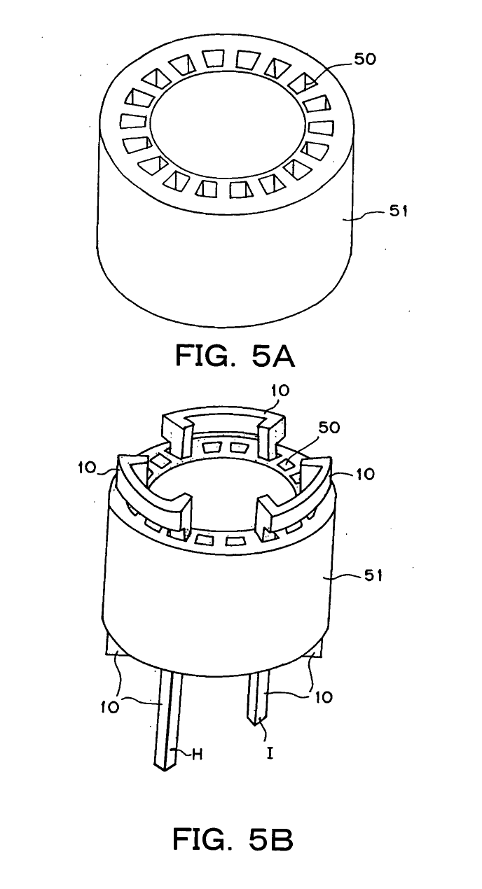

FIG. 5 illustrates another stator suitable for inserting a cable 10 according to a preferred embodiment of the present invention; FIG. 5A illustrates the stator; and FIG. 5B illustrates the state in which one of cable 10 is inserted in the stator with both ends of the cable 10 unconnected.

The cable 10 in the present embodiment can be installed in a stator 51 having closed slots 50, i.e., slots with no opening in the direction parallel with the axial direction of the slot as shown in FIG. 5A, by thread winding, i.e., inserting a cable 10 from the top of certain closed slot 50 downward while inserting a cable 10 from the bottom of the closed slot adjacent there to upward, as shown in FIG. 5B. Then a coil is formed by soldering or the like the respective conductor wires 11 together between the ends H and I of the cable 10 as shown in FIG. 5B.

The cable 10 according to the present embodiment can be installed in a stator having semi-closed slots by thread winding.

As such, since the cable 10 according to the present embodiment forms a single coil consisting of a single conductor wire which is wound in a plurality of slots 32 in a distributional manner, by bundling nine strings of conductor wire 11 together making a cable, winding the nine conductor wires 11 in a plurality of slots 32 of the stator 31, for instance, as shown in FIG. 3, and connecting each end of the nine conductor wires 11 between the different conductor wires 11 thereof, it is possible to perform an installation process for winding one conductor wire in a plurality of slots 32 in one assembly process, thereby increasing the productivity.

It is also possible to wind conductor wires for a motor with a long axial size in which winding the conductor wires in the slot by using an inserter is difficult.

It is also possible to wind a plurality of conductor wires 11 in a plurality of slots while the plurality of the conductor wires 11 are aligned well and therefore the wires 11 are wound in a well aligned fashion.

It is also possible to use conductor wires other than the flat conductor wire formed into a pine needle, thereby being applicable to a high-voltage specification. Also, it does not require large-scale winding equipment such as an inserter, eliminating the use of the pine needle shaped flat conductor wire, thereby reducing the associated costs.

Note that it is also possible to configure an armature including motor, generator and linear coil by using the cable 10 according to the present embodiment.

The cable 10 according to the present embodiment, while configured for installing in a stator, can also be installed in a rotor.

1. A cable for winding coil, wherein a plurality of conductor wires are bundled so as to wind said plurality of conductor wires in a plurality of slots in an armature, each end of said plurality of the conductor wires is connected between different wires thereof, thereby forming a coil wound in said plurality of slots in a distributional manner.

2. A cable for winding coil, wherein a plurality of conductor wires are bundled so as to wind said plurality of conductor wires in three or more slots in an armature, and each end of said plurality of the conductor wires is connected between different wires thereof, thereby forming a coil wound continuously in said three or more slots.

3. A cable for winding coil, wherein a plurality of conductor wires are bundled so as to wind said plurality of conductor wires in a plurality of slots in an armature, and each end of said plurality of the conductor wires is connected between different wires thereof, thereby forming a plurality of poles in said armature.

4. A cable for winding coil, wherein a first conductor wire and a second conductor wire are bundled together so as to wind said first conductor wire and said second conductor wire in a plurality of slots in an armature, and one end of said first conductor wire is connected with an end of said second conductor wire coming out of the same slot from which the other end of said first conductor wire comes out, thereby forming a coil consisting of said first and second conductor wires.

5. The cable for winding coil according to claim 1, wherein said conductor wire is a flat conductor wire.

6. The cable for winding coil according to claim 1, wherein said cable for winding coil is bent at predefined intervals, thereby being in a wave form.

7. The cable for winding coil according to claim 1, wherein said cable for winding coil is covered with an insulation coating thereon.

8. The cable for winding coil according to claim 1, wherein said slot is featured in a stator of said armature.

9. The cable for winding coil according to claim 1, wherein said slot is a closed slot and the cable for winding coil is installed in said closed slot by thread winding.

10. The cable for winding coil according to claim 1, wherein said coil is a plurality of independent coils.

11. An armature, wherein a cable for winding coil being formed by bundling a plurality of conductor wires so as to wind said plurality of conductor wires in a plurality of slots in a stator forms a coil wound in said plurality of slots in a distributional manner by connecting each end of said plurality of conductor wires between different wires thereof.

12. An armature, wherein a cable for winding coil being formed by bundling a plurality of conductor wires so as to wind said plurality of conductor wires in three or more slots forms a coil wound continuously in said three or more slots by connecting each end of said plurality of conductor wires between different wires thereof.

13. An armature, wherein a cable for winding coil being formed by bundling a plurality of conductor wires so as to wind said plurality of conductor wires in a plurality of slots forms a plurality of poles by connecting each end of said plurality of conductor wires between different wires thereof.

14. An armature, wherein a cable for winding coil being formed by bundling a first conductor wire and a second conductor wire together so as to wind said first conductor wire and said second conductor wire in a plurality of slots forms a coil consisting of said first and second conductor wires by connecting one end of said first conductor wire with an end of said second conductor wire coming out of the same slot from which the other end of said first conductor wire comes out.

15. The armature according to claim 11, wherein said conductor wire is a flat conductor wire.

16. The armature according to claim 11, wherein said cable for winding coil is bent at predefined intervals, thereby being in a wave form.

17. The armature according to claim 11, wherein said cable for winding coil is covered with an insulation coating thereon.

18. The armature according to claim 11, wherein said slot is featured in a stator of the armature.

19. The armature according to claim 11, wherein said slot is a closed slot and said cable for winding coil is installed in said closed slot by thread winding.

20. The armature according to claim 11, wherein said coil is a plurality of independent coils.

21. A winding tooling, wherein
a tooling member is disposed for bundling a plurality of conductor wires while maintaining the alignment of said plurality of conductor wires; and
said tooling member is featured with a hole whose cross-section shape is the same as the cross-section shape of a slot in an armature and the alignment of said plurality of conductor wires is established by said hole.

22. The winding tooling according to claim 21, wherein
each of said plurality of conductor wires can slide in said hole.

23. The winding tooling according to claim 21, wherein
said conductor wire is a flat conductor wire.

24. A coil winding method, wherein
a plurality of conductor wires are bundled whose whole cross-section shape is approximately the same as the cross-section shape of a slot of an armature;
said bundled plurality of conductor wires are wound continuously in three or more of said slots; and
each end of said bundled plurality of conductor wires is connected between different wires thereof; thereby forming a coil wound continuously in said three or more slots.

25. The coil winding method according to claim 24, wherein
said conductor wire is a flat conductor wire.
